(19) United States
(12) Patent Application Publication
(10) Pub. No.: US 2013/0240012 A1
(43) Pub. Date: Sep. 19, 2013

(54) PHOTOVOLTAIC SYSTEM

(71) Applicant: SHARP KABUSHIKI KAISHA, Osaka (JP)

(72) Inventors: Yoshifumi YAOI, Osaka (JP); Kohtaroh Kataoka, Osaka (JP); Kohichiroh Adachi, Osaka (JP); Masatomi Harada, Osaka (JP); Yoshiji Ohta, Osaka (JP); Hiroshi Iwata, Osaka (JP)

(73) Assignee: Sharp Kabushiki Kaisha, Osaka (JP)

(21) Appl. No.: 13/834,520

(22) Filed: Mar. 15, 2013

(30) Foreign Application Priority Data
Mar. 16, 2012 (JP) 2012-060906

(51) Int. Cl. H01L 31/04

(52) U.S. Cl. CPC H02S 10/00
USPC 136/244

(57) ABSTRACT

A photovoltaic system includes multiple series module units in each of which multiple photovoltaic modules are connected in series, multiple photovoltaic elements being implemented on a module implementation unit in each of the photovoltaic modules. The series module units are connected to each other in parallel, and the photovoltaic modules arranged in a same series stage are connected to each other in parallel.

### CROSS-REFERENCE TO RELATED APPLICATION

This application claims priority under 35 U.S.C. §119(a) on Patent Application No. 2012-060906 filed in Japan on Mar. 16, 2012, the entire contents of which are herein incorporated by reference.

### BACKGROUND OF THE INVENTION

1. Field of the Invention

The present invention relates to a photovoltaic system in which series module units, in which photovoltaic modules are connected in series, are connected to each other in parallel, and photovoltaic modules arranged in the same series stage are connected to each other in parallel.

2. Description of the Related Art

The development of photovoltaic technology that applies solar cells has been accompanied by demand for the generation of large amounts of power using photovoltaics. Also, various proposals have been made regarding the decrease in output that is an obstacle when stably generating large amounts of power, examples of which involve the connections between solar cells, the arrangement of solar cells, and shade counter-measures for shaded areas that fall on solar cells.

Among these proposals, a shade counter-measure has been proposed in which a shaded area is envisioned in advance and then addressed since a shaded area brings a normally unforeseeable decrease in output (e.g., see JP 2002-237612A, which is hereinafter referred to as “Patent Document 1”).

However, with the technology disclosed in Patent Document 1, a decrease in output due to a shaded area is compensated for by disposing a large number of alternate solar cell modules in places where shaded areas appear. This means is effective if it is known in advance that a shaded area appears in a fixed manner, but since shaded areas vary greatly depending on the movement of the sun (sunlight) and the location, the technology disclosed in Patent Document 1 cannot be an effective shade counter-measure, and has a problem that it is difficult to obtain stable output.

### SUMMARY OF THE INVENTION

The present invention provides a photovoltaic system in which multiple series module units, in which multiple photovoltaic modules are connected in series, are connected in parallel, and photovoltaic modules arranged in the same series stage in the series module units are connected to each other in parallel, and therefore even if a shaded area appears on a series module unit and the current pathway in the series module unit is suppressed (obstructed), the power generation area ratio is improved over the irradiated area ratio of the photovoltaic module, and the extracted power (power generation efficiency) is improved.

A photovoltaic system according to the present invention is a photovoltaic system including: a plurality of series module units in each of which a plurality of photovoltaic modules are connected in series, a plurality of photovoltaic elements being implemented on a module implementation unit in each of the photovoltaic modules, wherein the series module units are connected to each other in parallel, and photovoltaic modules arranged in a same series stage are connected to each other in parallel.

Accordingly, the photovoltaic system according to this aspect includes multiple series module units in each of which multiple photovoltaic modules are connected in series, and photovoltaic modules arranged in the same series stage in the parallel-connected series module units are connected to each other in parallel. For this reason, even if a shaded area appears on a series module unit and the current pathway in that series module unit is suppressed (obstructed), current from photovoltaic power can flow via a current pathway that passes through other parallel-connected series module units, thus improving the power generation area ratio relative to the irradiation area ratio of the photovoltaic modules and improving the extracted power (power generation efficiency).

Also, in the photovoltaic system of the present invention, the photovoltaic modules arranged in the same series stage in the series module units may be arranged so as to be distributed two-dimensionally.

Accordingly, in the photovoltaic system according to this aspect, photovoltaic modules that are connected in the same series stage in the series module units are arranged so as to be distributed two-dimensionally, and therefore it is possible to effectively avoid the influence of a shaded area on multiple photovoltaic modules arranged in the same series stage, thus preventing the current pathways of the series module unit from being suppressed by the influence of a shaded area, and further improving the power generation area ratio.

Also, in the photovoltaic system of the present invention, the series module units may be arranged two-dimensionally, and the photovoltaic modules in each of the series module units may be arranged in a double-back pattern.

Accordingly, in the photovoltaic system according to this aspect, the series module units are each configured by photovoltaic modules arranged in a double-back pattern, and therefore it is possible to two-dimensionally arrange the series module units in a dense manner, thus reliably distributing the photovoltaic modules according to the arrangement of the series module units, and further improving resistance to shaded areas.

Also, the photovoltaic system of the present invention, may further include: power conversion units that are connected to the photovoltaic modules and perform DC-DC conversion on output of the photovoltaic modules, wherein the photovoltaic modules may be interconnected with each other via the power conversion units.

Accordingly, in the photovoltaic system according to this aspect, the photovoltaic modules are interconnected with each other via the power conversion units that perform DC-DC conversion on their output, thus making it possible to extract power that has been adjusted by the power conversion units regardless of the power-generating state of the photovoltaic modules.

Also, in the photovoltaic system of the present invention, the power conversion units may boost an output voltage of the photovoltaic modules.

Accordingly, in the photovoltaic system according to this aspect, the output voltage of the photovoltaic modules is boosted, and therefore the output current relatively decreases, thus suppressing the occurrence of ohmic loss caused by current in current pathways, and improving the power extraction efficiency.

Also, in the photovoltaic system of the present invention, the power conversion units may have a boosting factor that is fixed at one value.

Accordingly, in the photovoltaic system according to this aspect, the power conversion units have a boosting factor that is fixed at one value, and therefore there is no need to adjust the control signal for controlling the boosting factor of the power conversion units, thus simplifying the control signal generation unit so as to reduce the installation cost of the power conversion units, and also improving reliability.

Also, in the photovoltaic system of the present invention, the power conversion units may be configured such that output of a plurality of the photovoltaic modules arranged in the same series stage in the series module units is input in parallel.

Accordingly, since the photovoltaic system according to this aspect is configured such that the output of multiple photovoltaic modules arranged in the same series stage is input in parallel, it is possible to suppress the number of power conversion units needed by the system so as to reduce the number of parts and simplify the connection configuration, thus suppressing installation cost and maintenance cost and improving reliability.

Also, in the photovoltaic system of the present invention, the power conversion units may be arranged so as to be distributed two-dimensionally.

Accordingly, in the photovoltaic system according to this aspect, the power conversion units that receive output of multiple photovoltaic modules in parallel are arranged so as to be distributed two-dimensionally, and therefore it is possible to shorten the wiring configuration, thus reliably suppressing ohmic loss in current pathways.

Also, in the photovoltaic system of the present invention, the power conversion units may be individually connected to the photovoltaic modules.

Accordingly, in the photovoltaic system according to this aspect, the power conversion units are individually connected to the photovoltaic modules, and therefore it is possible to individually convert the output of the photovoltaic modules, thus reliably and effectively suppressing ohmic loss in current pathways.

Also, in the photovoltaic system of the present invention, the power conversion units may be implemented on the module implementation units.

Accordingly, in the photovoltaic system according to this aspect, the power conversion units are implemented on the module implementation units of the photovoltaic modules, and therefore it is possible to substantially omit the arrangement process that accompanies the arrangement of the power conversion units, thus making the implementation of the power conversion units similar to the implementation of the photovoltaic modules, and ensuring reliability of the power conversion units.

Also, in the photovoltaic system of the present invention, the photovoltaic modules may each include series element units in each of which a plurality of the photovoltaic elements are connected in series, the series element units may be connected to each other in parallel, and the photovoltaic elements arranged in a same series stage may be connected to each other in parallel, and the photovoltaic elements arranged in the same series stage in the series element units may be arranged so as to be distributed two-dimensionally.

Accordingly, in the photovoltaic system according to this aspect, the photovoltaic elements in each photovoltaic module are connected in series and in parallel in a two-dimensional array, and are arranged so as to be distributed two-dimensionally, thus suppressing the influence of a shaded area in each photovoltaic module as well so as to further improve resistance to shaded areas.

A photovoltaic system according to the present invention includes multiple series module units in each of which multiple photovoltaic modules are connected in series, and photovoltaic modules arranged in the same series stage in the parallel-connected series module units are connected to each other in parallel.

Accordingly, in the photovoltaic system according to the present invention, even if a shaded area appears on a series module unit and the current pathway in that series module unit is suppressed (obstructed), current from photovoltaic power can flow via a current pathway that passes through other parallel-connected series module units, thus improving the power generation area ratio relative to the irradiation area ratio of the photovoltaic modules and improving the extracted power (power generation efficiency).

### BRIEF DESCRIPTION OF THE DRAWINGS

FIG. 1A is an equivalent circuit diagram of a conventional photovoltaic module array for comparison with the present invention;

FIG. 1B is a schematic diagram illustratively showing a layout pattern of photovoltaic modules in the photovoltaic module array shown in FIG. 1A, and an envisioned shaded area;

FIG. 2A is an equivalent circuit diagram of a photovoltaic module array applied to the present invention;

FIG. 2B is a schematic diagram illustratively showing a layout pattern of photovoltaic modules in the photovoltaic module array shown in FIG. 2A, and an envisioned shaded area;

FIG. 3A is an equivalent circuit diagram of a photovoltaic module array applied to the present invention;

FIG. 3B is a schematic diagram illustratively showing a layout pattern of photovoltaic modules in the photovoltaic module array shown in FIG. 3A, and an envisioned shaded area;

FIG. 4 is a comparison chart in which main configurations of the conventional photovoltaic module array and the photovoltaic module arrays according to the present invention are organized in a table format;

FIG. 5 is a characteristic graph showing a relationship between extracted power and sunlit area percentage in a photovoltaic module array applied to the present invention;

FIG. 6A is a connection diagram showing connections between photovoltaic modules in a photovoltaic system according to Embodiment 1 of the present invention;

FIG. 6B is a connection diagram showing an example of connections between photovoltaic elements built into the photovoltaic module shown in FIG. 6A;

FIG. 7A is an arrangement diagram showing a layout (Working Example 1) of photovoltaic modules in the photovoltaic system according to Embodiment 1 of the present invention;

FIG. 7B is an arrangement diagram showing a layout (Working Example 2) of photovoltaic modules in the photovoltaic system according to Embodiment 1 of the present invention;

FIG. 8 is a block diagram showing a block view of an arrangement of power conversion units connected to photovoltaic modules in a photovoltaic system according to Embodiment 2 of the present invention;

FIG. 9 is a block diagram showing a block view of an arrangement of power conversion units connected to photovoltaic modules in the photovoltaic system according to Embodiment 2 of the present invention;

FIG. 10 is a schematic circuit diagram showing an overview of internal circuitry of the power conversion units shown in FIG. 8; and

FIG. 11 is an output conceptual diagram conceptually showing output when system interconnection is carried out by connecting photovoltaic systems according to Embodiment 3 of the present invention to a power system.

### DESCRIPTION OF THE PREFERRED EMBODIMENT

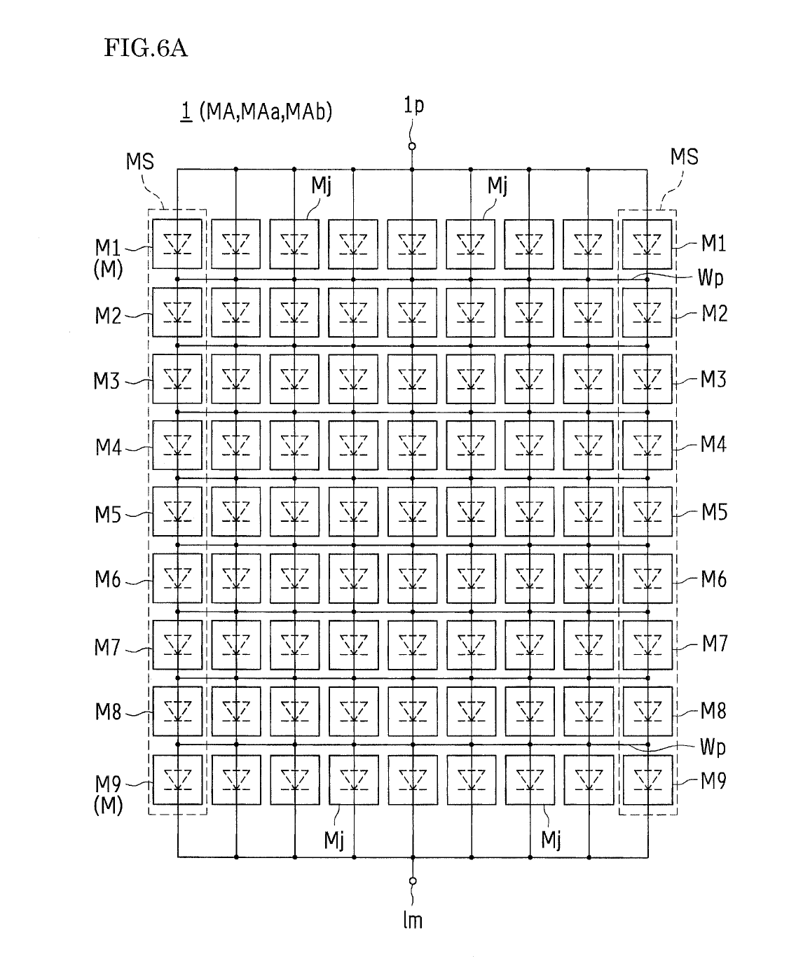

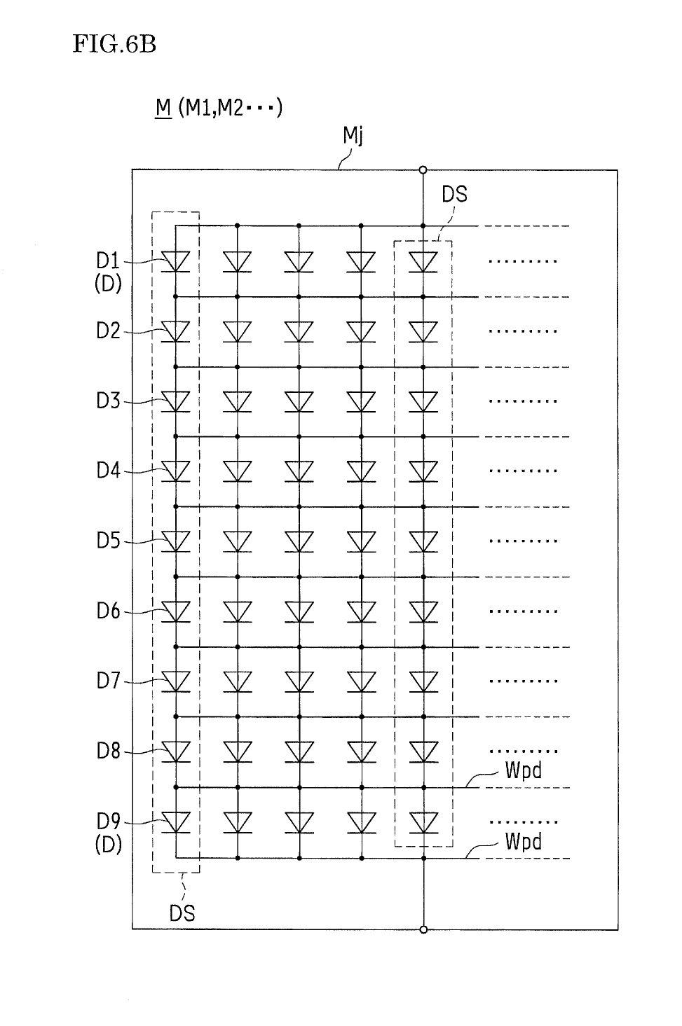

Hereinafter, embodiments of the present invention will be described with reference to the drawings. First, the principle of photovoltaic module arrays applied to the present invention (photovoltaic system) will be described, and then embodiments will be described with reference to FIGS. 6A to 11.

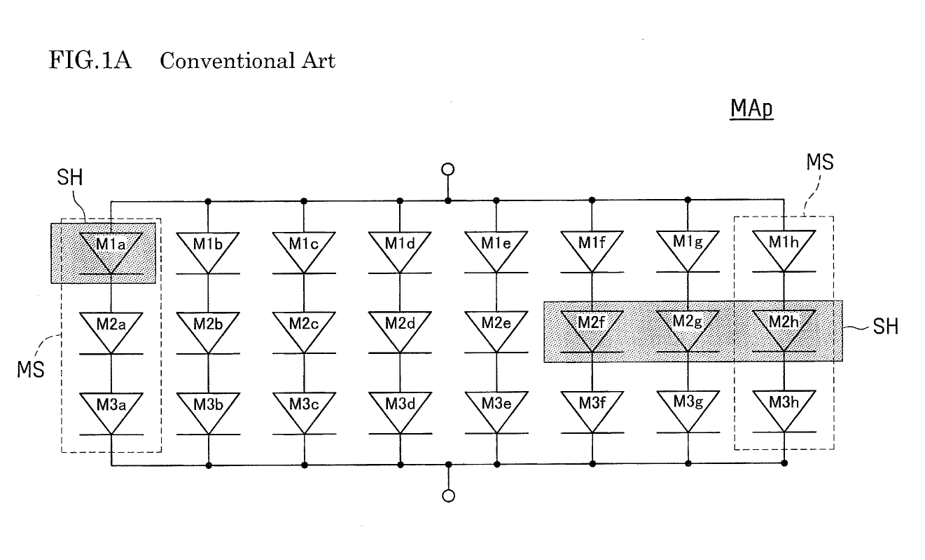

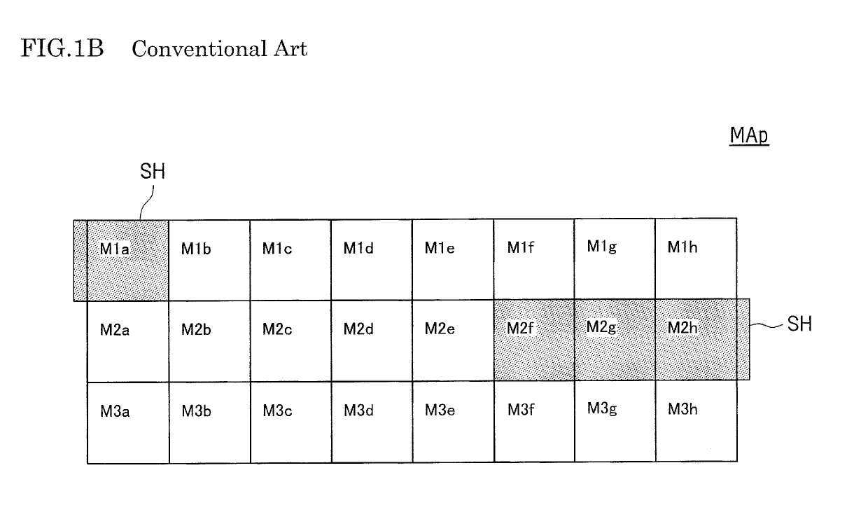

Principle of photovoltaic module arrays applied to present invention Configurations, operations, and effects of a photovoltaic module array MAa and a photovoltaic module array MAb will be described below as the “principle” with reference to FIGS. 1A to 5. In order to facilitate understanding of the operations and effects, a conventional photovoltaic module array MAp will be described first.

FIG. 1A is an equivalent circuit diagram of a conventional photovoltaic module array MAp for comparison with the present invention (connection diagram of photovoltaic modules M).

FIG. 1B is a schematic diagram illustratively showing a layout pattern of the photovoltaic modules M in the photovoltaic module array MAp shown in FIG. 1A, and an envisioned shaded area SH.

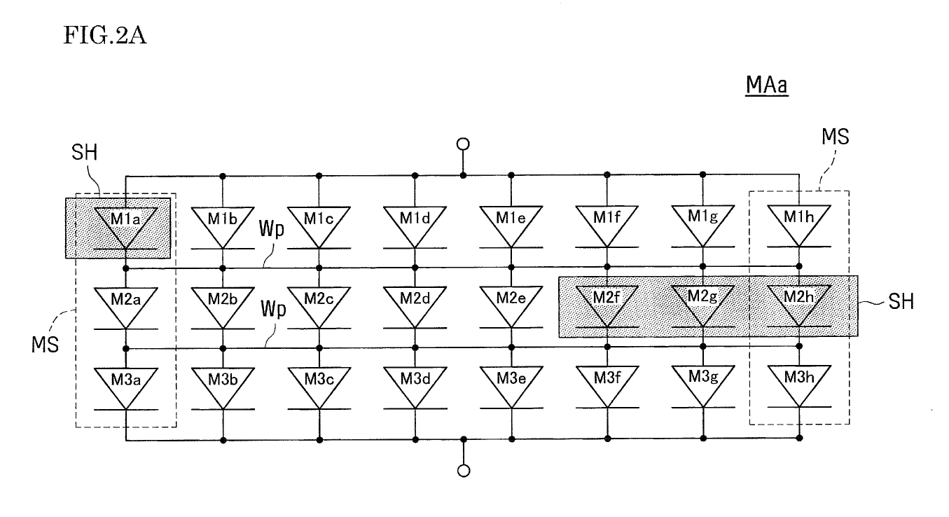

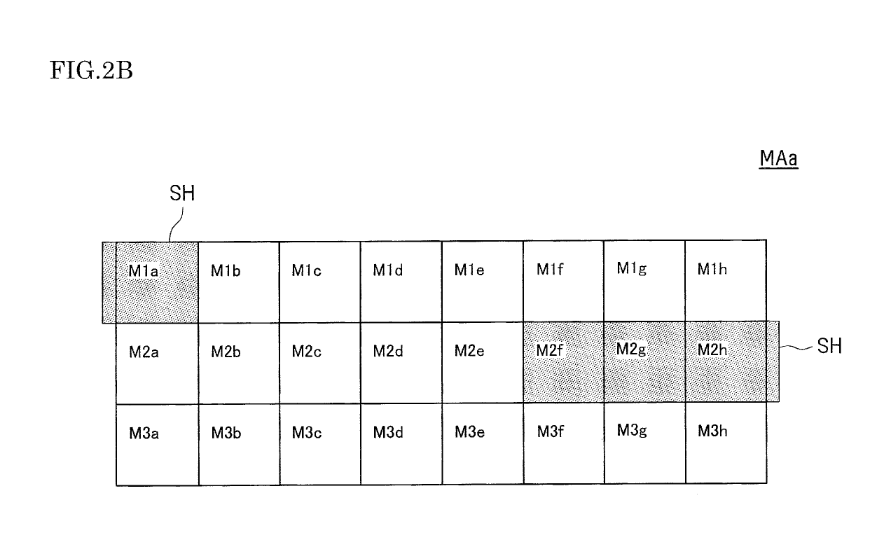

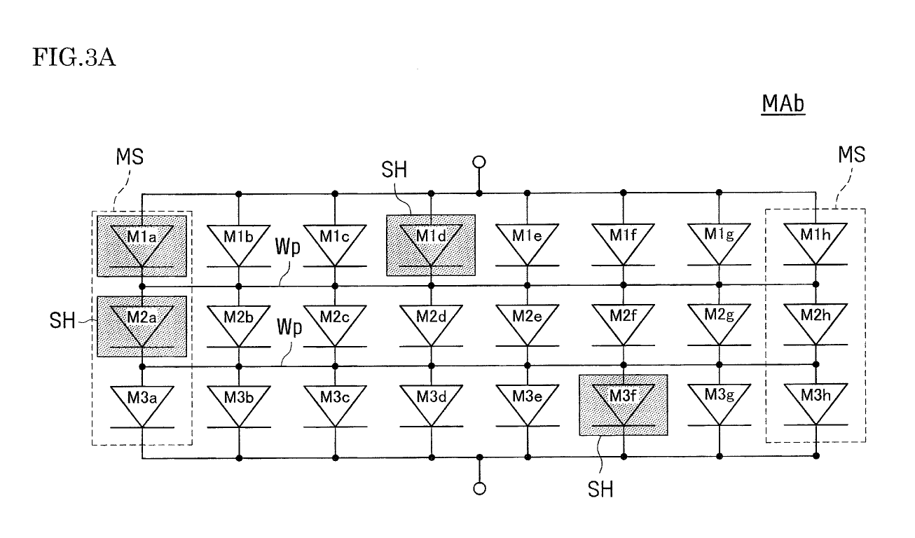

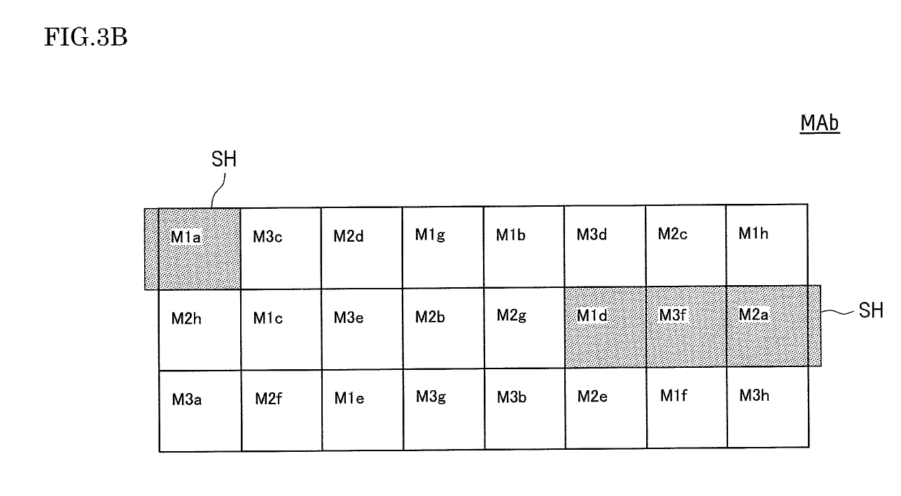

The conventional photovoltaic module array MAp includes series module units MS that are each formed by multiple (e.g., three) photovoltaic modules M being connected in series. For the sake of clarity in the description, the photovoltaic modules M are appended with individual reference signs according to their arrangement, and thus are denoted in the format of M . . . . Note that they will sometimes simply be referred to as photovoltaic modules M when there is no particular need to distinguish between them. The same follows for the photovoltaic module array MAa (FIGS. 2A and 2B) and the photovoltaic module array MAb (FIGS. 3A and 3B) that are described later.

Although each photovoltaic module M is internally provided with multiple photovoltaic elements D (see FIG. 6B), it is shown in a simplified manner with a single diode symbol that indicates the directionality and the current pathway in order to facilitate understanding. The same follows for the other photovoltaic modules M that are described later.

The photovoltaic module array MAp includes a series module unit MS configured by photovoltaic modules M1a, M2a, and M3a, a series module unit MS configured by photovoltaic modules M1b, M2b, and M3b, a series module unit MS configured by photovoltaic modules M1c, M2c, and M3c, a series module unit MS configured by photovoltaic modules M1d, M2d, and M3d, . . . , and a series module unit MS configured by photovoltaic modules M1h, M2h, and M3h. In other words, the photovoltaic module array MAp includes eight series module units MS.

The ends of the eight series module units MS are connected to each other in parallel. Accordingly, the photovoltaic module array MAp has a three-series×eight-parallel configuration, and includes 24 photovoltaic modules M. Also, each series module unit MS in the photovoltaic module array MAp forms an independent series module group that is electrically insulated and separated from the other series module units MS.

The following envisions the case where a shaded area SH falls on the layout pattern of photovoltaic modules M in the photovoltaic module array MAp (FIG. 1B). Specifically, the shaded area SH falls on the photovoltaic module M1a, the photovoltaic module M2f, the photovoltaic module M2g, and the photovoltaic module M2h. Accordingly, the photovoltaic module M1a, the photovoltaic module M2f, . . . , and the photovoltaic module M2h are in a non-power-generating state, and cannot pass a current. Note that in the equivalent circuit in FIG. 1A, the shaded area SH is shown overlapping on these photovoltaic modules M.

Since current does not pass through the photovoltaic module M1a, the series module unit MS that includes the photovoltaic modules M2a and M3a is overall incapable of generating power, regardless of including the photovoltaic modules M2a and M3a that are being irradiated with light. Also, since current does not pass through the photovoltaic module M2f, the series module unit MS that includes the photovoltaic modules MY and M3f is overall incapable of generating power, regardless of including the photovoltaic modules M1f and M3f that are being irradiated with light. Similarly, the series module unit MS that includes the photovoltaic module M2g and the photovoltaic module M2h are also overall incapable of generating power. In other words, the power generating state can only be ensured in the four series module units MS that include the photovoltaic modules M1b to M1e.

Accordingly, regardless of the fact that the photovoltaic module array MAp has a sunlit area ratio of 20/24(=0.83), the power generation area ratio (ratio of the area that is in the power generating state and contributes to effective output to the overall area) is 12/24(=0.5=50%), and therefore the power generation efficiency is low at 50% of the overall area.

FIG. 2A is an equivalent circuit diagram of the photovoltaic module array MAa applied to the present invention (connection diagram of photovoltaic modules M).

FIG. 2B is a schematic diagram illustratively showing a layout pattern of the photovoltaic module array MAa shown in FIG. 2A, and an envisioned shaded area SH.

The photovoltaic module array MAa includes series module units MS that are each formed by multiple (e.g., three) photovoltaic modules M being connected in series. Specifically, similarly to the photovoltaic module array MAp, the photovoltaic module array MAa includes a series module unit MS configured by photovoltaic modules M1a, M2a, and M3a, a series module unit MS configured by photovoltaic modules M1b, M2b, and M3b, . . . , and a series module unit MS configured by photovoltaic modules M1h, M2h, and M3h. In other words, similarly to the photovoltaic module array MAp, the photovoltaic module array MAa includes eight series module units MS.

The ends of the eight series module units MS are connected to each other in parallel. Accordingly, the photovoltaic module array MAa has a three-series×eight-parallel configuration, and includes 24 photovoltaic modules M. Also, each series module unit MS in the photovoltaic module array MAa forms a series module group.

Unlike the photovoltaic module array MAp, the photovoltaic modules M connected (arranged) in the same series stage in the series module units MS of the photovoltaic module array MAa are connected to each other in parallel via parallel wiring Wp. Specifically, the photovoltaic module array MAa is configured such that parallel connection points are formed in the row direction in addition to the series connection points in the column direction in the series module units MS, so as to have a two-dimensional array of connection points formed by connection points in both the row direction and the column direction.

Assuming that the overall light-receiving face area in the photovoltaic module array MAp is the same as the overall light-receiving face area in the photovoltaic module array MAa, the photovoltaic module array MAa has the same power generating capacity as the photovoltaic module array MAp when the shaded area SH is not taken into consideration.

The following envisions the case where a shaded area SH falls on the layout pattern of photovoltaic modules M in the photovoltaic module array MAa (FIG. 2B). The state envisioned for the shaded area SH is the same as the case with the photovoltaic module array MAp. Specifically, the shaded area SH falls on the photovoltaic module M1a, the photovoltaic module M2f, the photovoltaic module M2g, and the photovoltaic module M2h. Accordingly, the photovoltaic module M1a, the photovoltaic module M2f, . . . , and the photovoltaic module M2h are in a non-power-generating state, and cannot pass a current. Note that in the equivalent circuit in FIG. 2A, the shaded area SH is shown overlapping on photovoltaic modules M.

Even though the photovoltaic module array MAa includes photovoltaic modules M that cannot pass a current, current pathways are formed via the parallel wiring Wp since the same series stages in the series module units MS are connected to each other in parallel. Accordingly, the overall current that passes through the photovoltaic module array MAa is limited by, among the series stages, the series stage that has the smallest number of photovoltaic modules M in the power-generating state. In other words, the number of equivalent series that configure the current pathways is determined by the smallest number of photovoltaic modules M in the power-generating state in a series stage.

In the photovoltaic module array MAa shown in FIGS. 2A and 2B, the stage that has the smallest number of photovoltaic modules M in the power-generating state is the middle stage, for example. Specifically, among the eight photovoltaic modules M2a, . . . , M2e, M2f, M2g, and M2h in the middle stage, current passes through the photovoltaic modules M2a to M2e (the five photovoltaic modules M in the power-generating state in the middle stage), overall effective power generation is subject to the photovoltaic modules M that correspond to the five columns and three stages formed by the photovoltaic modules M2a to M2e (i.e., subject to the power generation area of 5×3=15 photovoltaic modules M), and the ratio of the power generation area to the overall area is (15 photovoltaic modules M)/(24 photovoltaic modules M).

Accordingly, the photovoltaic module array MAa has a sunlit area ratio of 20/24(=0.83), which is the same as that of the photovoltaic module array MAp. Also, the power generation area ratio is 15/24(=0.625=62.5%), and the power generation efficiency is 62.5% of the overall area. In other words, a higher power generation area ratio can be ensured with the photovoltaic module array MAa than with the photovoltaic module array MAp, thus improving the power extraction efficiency and ensuring high power generation efficiency.

As described above, compared to the photovoltaic module array MAp, the photovoltaic module array MAa applied to the present invention avoids influence with respect to the shaded area SH in actual use by improving the power transmission efficiency, thus making it possible to greatly improve the power generation area ratio and improve the power extraction efficiency.

FIG. 3A is an equivalent circuit diagram of the photovoltaic module array MAb applied to the present invention (connection diagram of photovoltaic modules M).

FIG. 3B is a schematic diagram illustratively showing a layout pattern of the photovoltaic module array MAb shown in FIG. 3A, and an envisioned shaded area SH.

Since the photovoltaic module array MAb is a further improvement on the photovoltaic module array MAa, mainly only the differences will be described below.

The photovoltaic module array MAb includes multiple series module units MS formed by multiple (e.g., three) photovoltaic modules M being connected in series, and has a two-dimensional array of connection points due to photovoltaic modules M that are connected (arranged) in the same series stage in the series module units MS being connected to each other in parallel via parallel wiring Wp.

Also, in addition to the connection topology having a two-dimensional array of connection points, the photovoltaic module array MAb further has an arrangement in which the arrangement (layout pattern) of the photovoltaic modules M is different from the equivalent circuit arrangement (i.e., has a distributed arrangement in which the photovoltaic modules M are randomly distributed).

In other words, in the photovoltaic module array MAb, the series module units MS are connected to each other in parallel, and the photovoltaic modules M arranged (connected) in the same series stage are connected to each other in parallel. Also, the photovoltaic modules M that are arranged in the same series stage in the series module units MS are arranged so as to be distributed two-dimensionally (arranged so as to be randomly distributed).

Specifically, in the case where the photovoltaic modules M are arranged so as to be randomly distributed, the photovoltaic modules M arranged in the upper stage in the equivalent circuit, for example, are arranged so as to be distributed in the upper stage, the middle stage, or the lower stage in the layout pattern, and the left/right arrangement positions of the photovoltaic modules M arranged in the same series stage in the equivalent circuit are arranged so as to be distributed differently in the layout pattern compared to the arrangement in the equivalent circuit.

A connection topology having a two-dimensional array of connection points for two-dimensionally arranged photovoltaic modules M (photovoltaic module array MAa, photovoltaic module array MAb), or an arrangement mode including an architecture in which the arrangement (layout pattern) of photovoltaic modules M is different from their arrangement in the equivalent circuit (photovoltaic module array MAb) is called a distributed arrangement architecture by the inventors of the present application.

In this way, according to the distributed arrangement architecture, even if a shaded area SH falls on the layout (arrangement photovoltaic modules M) in a concentrated manner, the fact that the photovoltaic modules M are arranged in a distributed manner in the equivalent circuit makes it possible to further suppress the influence of the shaded area SH on the series module units MS connected in series.

In the photovoltaic module array MAb, as shown in the equivalent circuit, the photovoltaic module M1a, the photovoltaic module M1b, . . . , and the photovoltaic module M1h are arranged so as to be connected in parallel in the upper stage; the photovoltaic module M2a, the photovoltaic module M2b, . . . , and the photovoltaic module M2h are arranged so as to be connected in parallel in the middle stage; and the photovoltaic module M3a, the photovoltaic module M3b, . . . , and the photovoltaic module M3h are arranged in the lower stage. Note that the connections in the equivalent circuit are similar to those in the photovoltaic module array MAa.

The connections between the photovoltaic modules M is the same in the equivalent circuit of the photovoltaic module array MAa and in the equivalent circuit of the photovoltaic module array MAb, but the photovoltaic module array MAb has a layout pattern in which, as shown in FIG. 3B, the photovoltaic module M1a, the photovoltaic module M3c, . . . , the photovoltaic module M2c, and the photovoltaic module M1h are arranged in order from left to right in the upper stage; the photovoltaic module M2h, the photovoltaic module M1c, . . . , the photovoltaic module M3f, and the photovoltaic module M2a are arranged in order from left to right in the middle stage; and the photovoltaic module M3a, the photovoltaic module M2f, . . . , the photovoltaic module M1f, and the photovoltaic module M3h are arranged in order from left to right in the lower stage.

In other words, the photovoltaic modules M are in a distributed arrangement according to which their arrangement in the layout pattern is different from their arrangement in the equivalent circuit. Note that the above-described layout pattern (FIG. 3B) is one example, and other layout patterns can also be applied.

The following envisions the case where a shaded area SH falls on the layout pattern of the photovoltaic modules M (FIG. 3B). Specifically, the shaded area SH falls in a manner of being concentrated at the left end of the upper stage and in the vicinity of the right end of the middle stage. More specifically, the shaded area SH falls on the photovoltaic module M1a, the photovoltaic module M1d, the photovoltaic module M3f, and the photovoltaic module M2a.

Accordingly, the photovoltaic module M1a, the photovoltaic module M1d, the photovoltaic module M3f, and the photovoltaic module M2a are in a non-power-generating state, and cannot pass a current. Note that in the equivalent circuit in FIG. 3A, the shaded area SH is shown overlapping on these photovoltaic modules M.

In the state where the shaded area SH falls on the photovoltaic module M1a, the photovoltaic module M1d, the photovoltaic module M3f, and the photovoltaic module M2a, in terms of the distributed arrangement in the equivalent circuit, the photovoltaic module M1a is arranged at the left end in the upper stage, the photovoltaic module M1d is arranged at the fourth position from the left in the upper stage, the photovoltaic module M2a is arranged at the left end in the middle stage, and the photovoltaic module M3f is arranged at the third position from the right in the lower stage.

In other words, in the respective series stages (the upper stage, the middle stage, and the lower stage), the number of photovoltaic modules M in the non-power-generating state is two in the upper stage, one in the middle stage, and one in the lower stage, and the largest number of photovoltaic modules M that are subjected to current limitation in the series module unit MS is restricted and suppressed to “two in the upper stage”. In other words, the smallest number of photovoltaic modules M in the power-generating state in a series stage is “six in the upper stage”.

Accordingly, six series module units MS are formed in accordance with these six photovoltaic modules M in the upper stage, and six current pathways are configured. Specifically, the connection state between the photovoltaic modules M that are not influenced by the shaded area SH is substantially a 3 (3-series)×6 (6-parallel) connection state in the equivalent circuit, and thus a decrease in the power transmission efficiency in the current pathways can be suppressed.

In other words, the photovoltaic module array MAb has a sunlit area ratio of 20/24(=0.83), which is the same as that of the photovoltaic module array MAa. Also, the power generation area ratio is 18/24(=0.75=75%), and the power generation efficiency is 75% of the overall area, and therefore the power generation area ratio of the photovoltaic module array MAb is higher than the power generation area ratio of the photovoltaic module array MAa (62.5%).

In other words, compared to the photovoltaic module array MAa applied to the present invention, the photovoltaic module array MAb applied to the present invention has a higher power generation area ratio and can further suppress a reduction in the power transmission efficiency even if the sunlit area ratio is the same, thus making it possible to improve the power extraction efficiency and ensure a higher overall power generation efficiency.

Note that the photovoltaic module array MAa and the photovoltaic module array MAb will sometimes simply be referred to hereinafter as the photovoltaic module arrays MA when there is no particular need to distinguish between them.

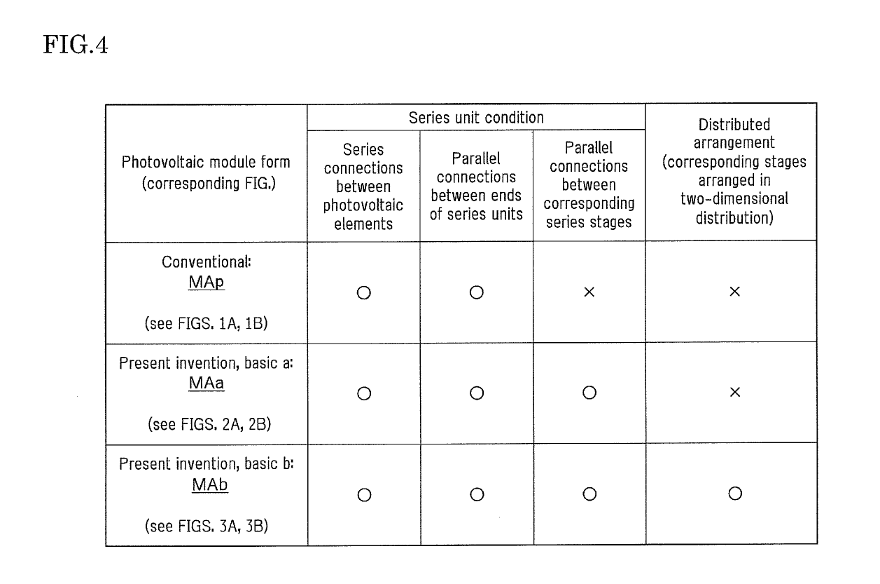

FIG. 4 is a comparison chart in which main configurations of the conventional photovoltaic module array MAp and the photovoltaic module arrays MA according to the present invention are organized in a table format.

As described above, the individual photovoltaic modules M that configure the series module unit MS of the conventional photovoltaic module array MAp are not connected to photovoltaic modules M of other series module units MS in the respective series stages. Parallel current pathways are only formed by connections between the ends of the series module units MS.

In the photovoltaic module array MAa (basic a: FIGS. 2A and 2B) applied to the present invention, the ends of the series module units MS are connected to each other in parallel, and the photovoltaic modules M arranged in the same series stage are also connected to each other in parallel. Accordingly, even if a current pathway is obstructed due to a shaded area SH falling on some of the series module units MS, for example, current flows via series module units MS that are connected in parallel and are operating in a normal manner via the parallel wiring Wp, thus suppressing the influence of the shaded area SH and improving the power extraction efficiency.

In the photovoltaic module array MAb (basic b: FIGS. 3A and 3B) applied to the present invention, in addition to the connections in the photovoltaic module array MAa, the layout of photovoltaic modules M arranged in the same series stage is a two-dimensional distributed arrangement. Thus further improves the power extraction efficiency.

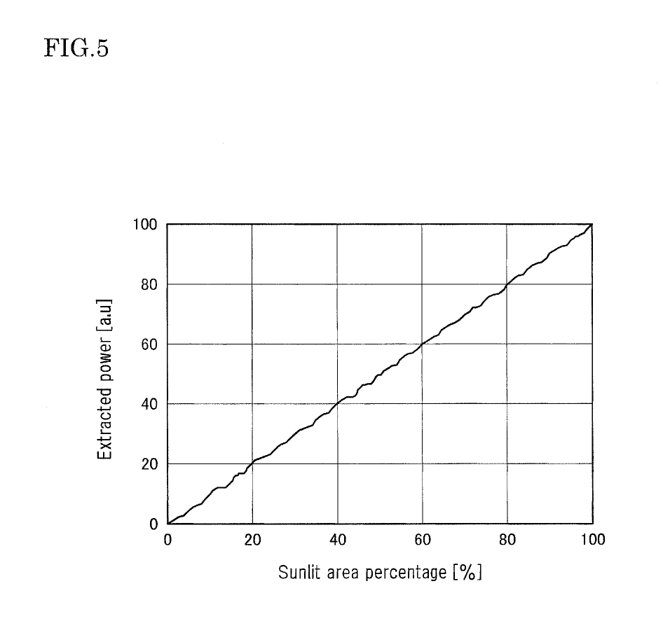

FIG. 5 is a characteristic graph showing a relationship between extracted power and sunlit area percentage in the photovoltaic module array MAa or the photovoltaic module array MAb applied to the present invention.

The horizontal axis indicates the sunlit area percentage (%), and the vertical axis indicates the extracted power (a.u.: arbitrary unit). The extracted power of 100 (a.u.) corresponds to the normal rated power (or maximum power), for example. Change in the sunlit area percentage corresponds to change in the so-called shaded area SH, to put it in other words.

Throughout various examinations, the inventors of the present application newly confirmed that the photovoltaic module array MAa and the photovoltaic module array MAb that apply the distributed arrangement architecture exhibit characteristics entirely different from those of the conventional photovoltaic module array MAp. Specifically, the photovoltaic module array MA according to the present embodiment obtains output (extracted power) that is substantially proportional to the sunlit area percentage. Accordingly, the photovoltaic module array MA can reliably prevent a drastic reduction in output even if a shaded area appears, and can ensure output that corresponds to the sunlit area percentage, thus obtaining high power generation efficiency.

The following describes a photovoltaic system 1 according to Embodiment 1 that specifically applies a photovoltaic module array MA (the photovoltaic module array MAa or the photovoltaic module array MAb).

### EMBODIMENT 1

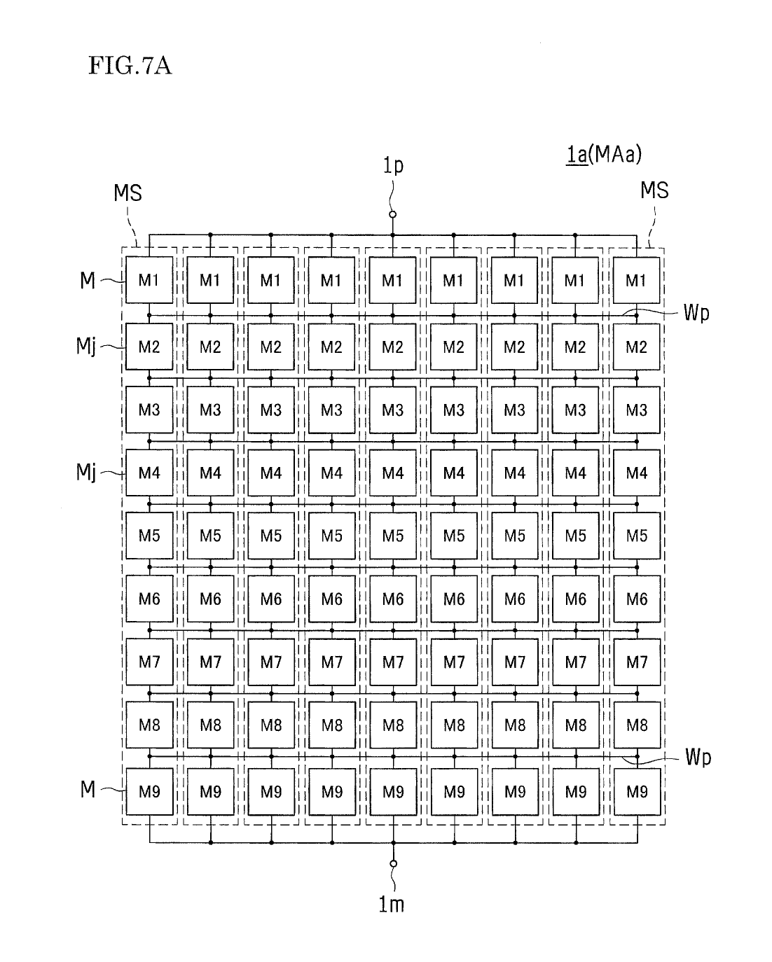

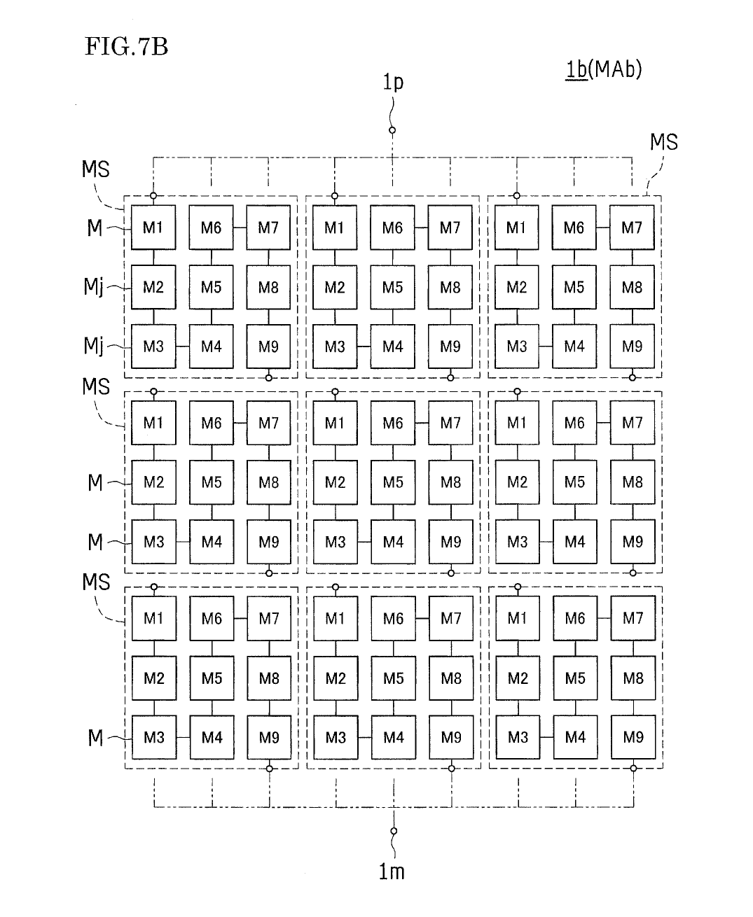

The photovoltaic system 1 according to the present embodiment will be described below with reference to FIGS. 6A to 7B.

FIG. 6A is a connection diagram showing connections between photovoltaic modules M in the photovoltaic system 1 according to Embodiment 1 of the present invention.

The photovoltaic system 1 of the present embodiment includes series module units MS in each of which multiple photovoltaic modules M (e.g., photovoltaic modules M1 to M9) are connected in series, and the series module units MS are connected in parallel. Also, the photovoltaic modules M arranged (connected) in the same series stage in the series module units MS are connected to each other in parallel. In other words, the configuration of the photovoltaic system 1 is similar to that of the photovoltaic module array MAa or the photovoltaic module array MAb described in the “principle” section.

Accordingly, in the photovoltaic system 1, each series module unit MS is formed by nine photovoltaic modules M1 (first position from a first terminal 1p side in the series stage) to M9 (ninth series stage from the first terminal 1p side) that are connected in series, and nine series module units MS are connected in parallel. In other words, the photovoltaic system 1 includes 81 photovoltaic modules M in a nine-series×nine-parallel configuration. Note that output of the photovoltaic system 1 is obtained from the first terminal 1p and a second terminal 1m at respective ends.

Also, each photovoltaic module M is a module (photovoltaic element group) that includes multiple photovoltaic elements D (see FIG. 6B) connected to each other, and generates a constant output. Since output having a constant magnitude is obtained by the photovoltaic modules M, the output of the photovoltaic modules M in the photovoltaic system 1 has a voltage that corresponds to “nine-series” and a current that corresponds to “nine-parallel”, and thus a large amount of power can be generated.

The photovoltaic modules M in the photovoltaic module array MA are connected by providing photovoltaic modules M in a nine-series×nine-parallel configuration with a two-dimensional array of connection points. If the layout of the photovoltaic modules M is similar to that in the photovoltaic module array MAa (FIG. 7A), effects similar to those of the photovoltaic module array MAa are obtained, and if the layout of the photovoltaic modules M is similar to that of the photovoltaic module array MAb (FIG. 7B), effects similar to those of the photovoltaic module array MAb are obtained.

As described above, the photovoltaic system 1 of the present embodiment includes multiple series module units MS in which multiple photovoltaic modules M (photovoltaic modules M1 to M9) are connected in series, each photovoltaic module M being formed by implementing multiple photovoltaic elements D on a module implementation unit Mj; the series module units MS are connected to each other in parallel, and photovoltaic modules M arranged in the same series stage are connected to each other in parallel.

Accordingly, the photovoltaic system 1 according to the present invention includes multiple series module units MS in each of which multiple photovoltaic modules M (e.g., the photovoltaic modules M1 to M9) are connected in series, and photovoltaic modules M arranged in the same series stage in the parallel-connected (nine-parallel) series module units MS are connected to each other in parallel. For this reason, even if a shaded area appears on a series module unit MS and the current pathway in that series module unit MS is suppressed (obstructed), current from photovoltaic power can flow via a current pathway that passes through other parallel-connected series module units MS, thus improving the power generation area ratio relative to the irradiation area ratio of the photovoltaic modules M (photovoltaic module array MA) and improving the extracted power (power generation efficiency).

The photovoltaic modules M each include a module implementation unit Mj. The module implementation unit Mj has a form in which, for example, multiple photovoltaic elements D are implemented on one translucent insulating substrate. Also, each module implementation unit Mj is provided with a first terminal 1p and a second terminal 1m.

Note that the layout of the photovoltaic modules M in the photovoltaic system 1 is the layout described with reference to either FIG. 7A (a layout corresponding to that of the photovoltaic module array MAa in the “principle” section) or FIG. 7B (a layout corresponding to that of the photovoltaic module array MAb in the “principle” section).

FIG. 6B is a connection diagram showing an example of connections between the photovoltaic elements D built into the photovoltaic modules M shown in FIG. 6A.

The photovoltaic modules M (photovoltaic modules M1 to M9) each include photovoltaic elements D (e.g., photovoltaic elements D1 to D9). The photovoltaic elements D1 to D9 are connected in series so as to configure a series element unit DS, for example, and the series element units DS are connected in parallel. In other words, in the present embodiment, a shaded area countermeasure is applied in each photovoltaic module M, and the photovoltaic elements D are both series-connected and parallel-connected, thus being connected via a two-dimensional array of connection points. Note that the photovoltaic element D is specifically a solar cell or the like.

The photovoltaic module M of the present embodiment includes multiple series element units DS in each of which multiple (e.g., nine) photovoltaic elements D (photovoltaic elements D1 to D9) are connected in series, and has a two-dimensional array of connection points in which photovoltaic elements D that are connected (arranged) in the same series stage in the series element units DS are connected to each other in parallel via the parallel wiring Wp.

Also, it is preferable that in addition to the connection topology having a two-dimensional array of connection points, the photovoltaic module M further has an arrangement in which the arrangement (layout pattern) of the photovoltaic elements D is different from the equivalent circuit arrangement (i.e., has a distributed arrangement in which the photovoltaic elements D are randomly distributed).

In other words, in the photovoltaic module M, the series element units DS are connected to each other in parallel, and the photovoltaic elements D arranged (connected) in the same series stage are connected to each other in parallel. Also, the photovoltaic elements D arranged in the same series stage in the series element units DS are arranged so as to be distributed two-dimensionally (arranged so as to be randomly distributed).

Specifically, in the case where the photovoltaic elements D are arranged so as to be randomly distributed (although FIGS. 3A and 3B show different members, they can be referenced for a specific example of the arrangement), the photovoltaic elements D arranged in the upper stage in the equivalent circuit, for example, are arranged so as to be distributed in the upper stage, the middle stage, or the lower stage in the layout pattern, and the left/right arrangement positions of the photovoltaic elements D arranged in the same series stage in the equivalent circuit are arranged so as to be distributed differently in the layout pattern compared to the arrangement in the equivalent circuit.

As described above, the photovoltaic module M includes series element units DS in each of which multiple photovoltaic elements D are connected in series, the series element units DS are connected to each other in parallel, and photovoltaic elements D arranged in the same series stage are connected to each other in parallel. Also, the photovoltaic elements D arranged in the same series stage in the series element units DS are arranged so as to be distributed two-dimensionally.

Accordingly, in the photovoltaic system 1 of the present embodiment, the photovoltaic elements D in each photovoltaic module M are connected in series and in parallel in a two-dimensional array, and are arranged so as to be distributed two-dimensionally, thus suppressing the influence of a shaded area in each photovoltaic module M as well so as to further improve resistance to shaded areas.

Note that the photovoltaic elements D may be simply connected in series. In other words, the photovoltaic elements D in the photovoltaic module M may have any connection topology as long as predetermined output is obtained.

FIG. 7A is an arrangement diagram showing a layout (Working Example 1) of photovoltaic modules M in a photovoltaic system 1a according to Embodiment 1 of the present invention.

The photovoltaic system 1a is configured including nine series module units MS in each of which photovoltaic modules M (photovoltaic modules M1 to M9) are connected in series, the series module units MS being connected in parallel. In other words, the connections correspond to those shown in FIG. 6A.

In the photovoltaic system 1a, the series module units MS are arranged linearly, and photovoltaic modules M arranged in the same series stage (e.g., the photovoltaic modules M1) are arranged one-dimensionally (in FIG. 7A, see the nine photovoltaic modules M1 arranged in a row in the horizontal direction, for example). Also, photovoltaic modules M arranged in the same series stage are connected to each other in parallel via the parallel wiring Wp.

In other words, the arrangement-related layout pattern corresponds to that of the photovoltaic module array MAa described in the “principle” section. Operations and effects obtained with the photovoltaic module array MAa are thus obtained here as well.

Note that the photovoltaic system 1a will sometimes be simply referred to as the photovoltaic system 1 when there is no particular need to distinguish between layouts.

FIG. 7B is an arrangement diagram showing a layout (Working Example 2) of photovoltaic modules M in a photovoltaic system 1b according to Embodiment 1 of the present invention.

The photovoltaic system 1b is configured including nine series module units MS in each of which photovoltaic modules M (photovoltaic modules M1 to M9) are connected in series, the series module units MS being connected in parallel. In other words, the connections correspond to those shown in FIG. 6A. Note that the parallel wiring Wp via which the same series stages in the series module units MS are connected to each other in parallel is not shown in FIG. 7B in consideration of making the figure easy to understand.

Also, the series module units MS are arranged so as to be distributed two-dimensionally in a 3×3 matrix. Accordingly, the photovoltaic modules M1 to M9 that configure each series module unit MS are arranged two-dimensionally so as to be distributed in the layout pattern. Specifically, the photovoltaic modules M1 for example are arranged so as to be distributed at nine positions (three positions vertically and three positions horizontally) out of 81 vertical and horizontal arrangement positions (nine positions vertically and nine positions horizontally) for the photovoltaic modules M.

In other words, the arrangement-related layout pattern corresponds to that of the photovoltaic module array MAb described in the “principle” section. Operations and effects obtained with the photovoltaic module array MAb are thus obtained here as well. Note that it is preferable that the extent of the distributed arrangement of the photovoltaic modules M is uniform in the photovoltaic modules M.

As described above, it is preferable that in the photovoltaic system 1b, photovoltaic modules M arranged in the same series stage in the series module units MS are arranged so as to be distributed two-dimensionally. According to this configuration, in the photovoltaic system 1b, photovoltaic modules M connected in the same series stage in the series module units MS are arranged so as to be distributed two-dimensionally, and therefore it is possible to effectively avoid the influence of a shaded area on multiple photovoltaic modules M arranged in the same series stage, thus preventing the current pathways of the series module unit MS from being suppressed by the influence of a shaded area, and further improving the power generation area ratio.

Also, in each of the series module units MS arranged two-dimensionally, the photovoltaic modules M1 to M9 are arranged so as to double back every three photovoltaic modules M in order to configure a square. In other words, it is preferable that in the photovoltaic system 1b, the series module units MS are arranged two-dimensionally, and the photovoltaic modules M in each series module unit MS are arranged in a double-back pattern.

Accordingly, in the photovoltaic system 1b, the series module units MS are each configured by photovoltaic modules M arranged in a double-back pattern, and therefore it is possible to two-dimensionally arrange the series module units MS in a dense manner, thus reliably distributing the photovoltaic modules M according to the arrangement of the series module units MS, and further improving resistance to shaded areas.

Note that the photovoltaic system 1b will sometimes be simply referred to as the photovoltaic system 1 when there is no particular need to distinguish between layouts.

### EMBODIMENT 2

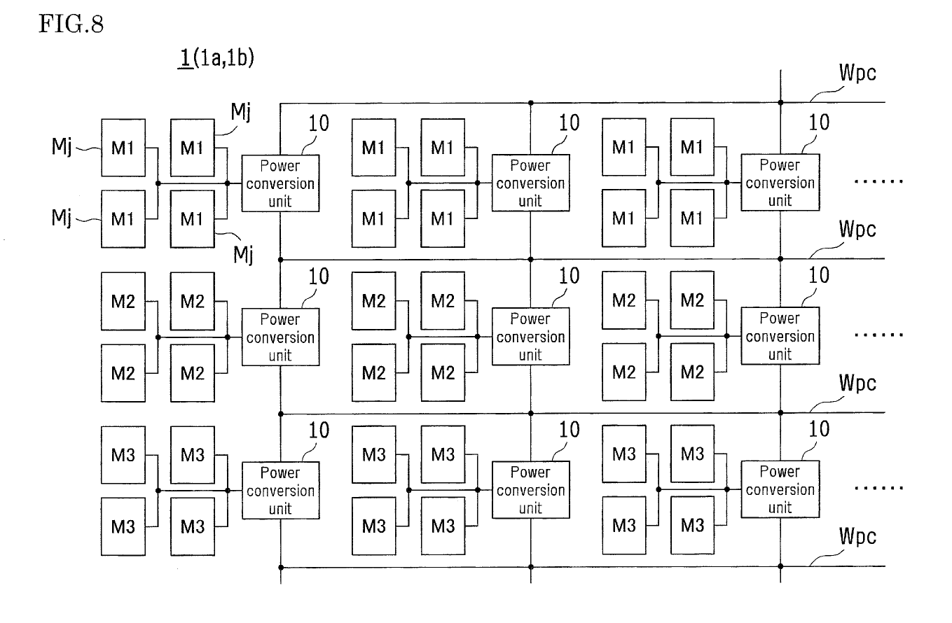

The following describes a photovoltaic system 1 (photovoltaic system 1a, photovoltaic system 1b) according to the present embodiment with reference to FIGS. 8 to 10.

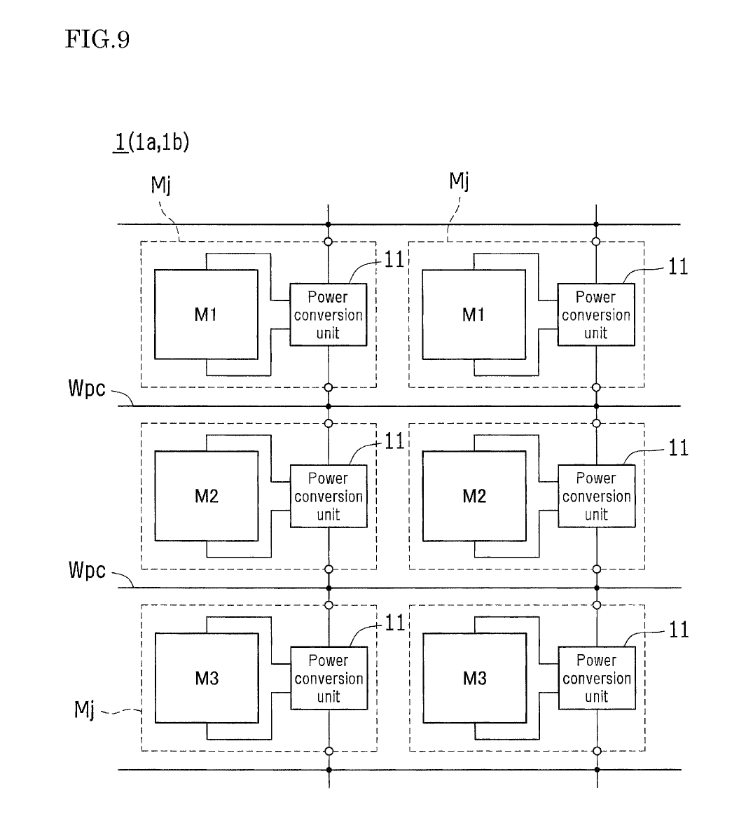

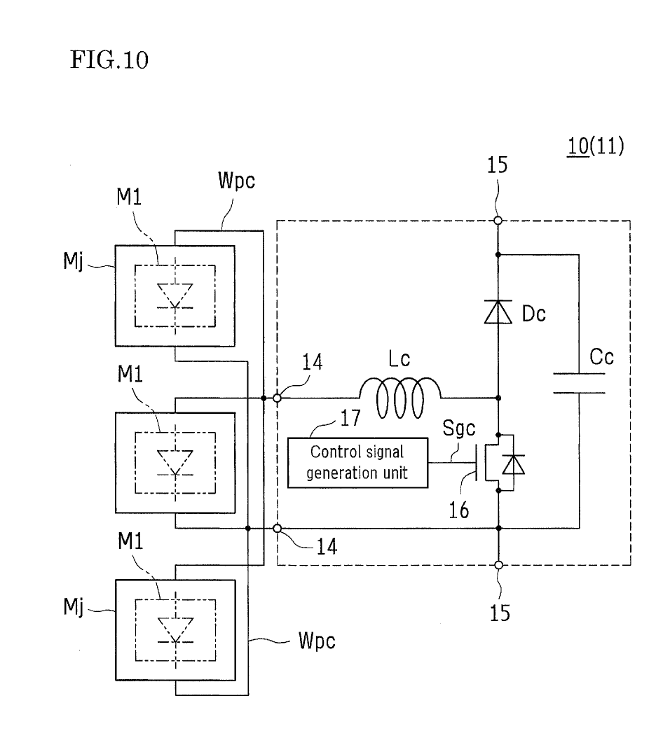

The photovoltaic system 1 of the present embodiment is obtained by applying a power conversion unit 10 (FIG. 8) or a power conversion unit 11 (FIG. 9) to the photovoltaic modules M included in the photovoltaic system 1 (photovoltaic system 1a, photovoltaic system 1b; simply referred to hereinafter as the photovoltaic system 1) of Embodiment 1. Accordingly, reference signs will be reused, and the description will focus on the differences. Also, the internal circuitry of the power conversion unit 10 and the power conversion unit 11 will be described with reference to FIG. 10.

FIG. 8 is a block diagram showing a block view of an arrangement of power conversion units 10 connected to photovoltaic modules M in the photovoltaic system 1 according to Embodiment 2 of the present invention.

The photovoltaic system 1 of the present embodiment includes multiple photovoltaic modules M1, multiple photovoltaic modules M2, multiple photovoltaic modules M3, and so on. The photovoltaic modules M1, the photovoltaic modules M2, the photovoltaic modules M3, and so on are respectively divided into three groups of four each, for example, and the groups are connected to each other in series and in parallel via power conversion units 10.

Specifically, the three groups of four photovoltaic modules M1 are connected in parallel via power conversion units 10 and parallel wiring Wpc, the three groups of four photovoltaic modules M2 are connected in parallel via power conversion units 10 and parallel wiring Wpc, and the three groups of four photovoltaic modules M3 are connected in parallel via power conversion units 10 and parallel wiring Wpc. Also, the photovoltaic modules M1, the photovoltaic modules M2, and the photovoltaic modules M3 are connected to each other in series via the power conversion units 10 that perform DC-DC conversion on the output of the photovoltaic modules M.

Note that as described in Embodiment 1, the photovoltaic modules M1 are photovoltaic modules arranged in the first stage on the first terminal 1p side in the series module units MS, the photovoltaic modules M2 are likewise photovoltaic modules arranged in the second stage, and the photovoltaic modules M3 are likewise photovoltaic modules arranged in the third stage.

Although Embodiment 1 described the example of the case where nine photovoltaic modules M1, nine photovoltaic modules M2, and nine photovoltaic modules M3 are connected in parallel, in the present embodiment, four photovoltaic modules M1, four photovoltaic modules M2, and four photovoltaic modules M3 respectively form one group, and three groups are connected in parallel.

Specifically, in the photovoltaic system 1, twelve photovoltaic modules M1, twelve photovoltaic modules M2, and twelve photovoltaic modules M3 are respectively connected in parallel, and each group of four photovoltaic modules M1, four photovoltaic modules M2, and four photovoltaic modules M3 is connected to a power conversion unit 10, thus being interconnected overall.

Note that the layout of the photovoltaic modules M1, the photovoltaic modules M2, and the photovoltaic modules M3 may be any layout. Examples of layouts that can be applied include a layout that corresponds to the photovoltaic system 1a and a layout that corresponds to the photovoltaic system 1b.

As described above, it is preferable that the photovoltaic system 1 includes power conversion units 10 that are connected to the photovoltaic modules M and perform DC-DC conversion on the output of the photovoltaic modules M, and the photovoltaic modules M are interconnected (connected) with each other via the power conversion units 10.

Accordingly, in the photovoltaic system 1, the photovoltaic modules M are interconnected with each other via the power conversion units 10 that perform DC-DC conversion on their output, thus making it possible to extract power that has been adjusted by the power conversion units 10 regardless of the power-generating state of the photovoltaic modules M.

Also, it is preferable that in the photovoltaic system 1, the power conversion units 10 boost the output voltage of the photovoltaic modules M. Accordingly, since the output voltage of the photovoltaic modules M is boosted in the photovoltaic system 1, the output current relatively decreases, thus suppressing the occurrence of ohmic loss caused by current in current pathways, and improving the power extraction efficiency.

Also, it is preferable that in the photovoltaic system 1, the power conversion units 10 are configured such that the output of multiple photovoltaic modules M (e.g., the four photovoltaic modules M1) arranged in the same series stage of series module units MS is input in parallel.

Accordingly, since the photovoltaic system 1 is configured such that the output of multiple photovoltaic modules M arranged in the same series stage is input in parallel, it is possible to suppress the number of power conversion units 10 needed by the system so as to reduce the number of parts and simplify the connection configuration, thus suppressing installation cost and maintenance cost and improving reliability.

Note that it is preferable that one group of (four) photovoltaic modules M connected to a power conversion unit 10 is arranged relatively closer compared to other photovoltaic modules M. The closely arranged photovoltaic modules M can be connected to each other and collectively input their output to the power conversion unit 10. Note that FIG. 8 illustrates connections, and the arrangement of the photovoltaic modules M can be set differently as shown in FIGS. 7A and 7B.

It is preferable that in the photovoltaic system 1, the power conversion units 10 are arranged so as to be distributed two-dimensionally as shown in FIG. 8. Note that the power conversion unit 10 can take the form of being implemented on the module implementation unit Mj of any one photovoltaic module M in the group (of four) to be connected to the input side.

FIG. 9 is a block diagram showing a block view of an arrangement of power conversion units 11 connected to photovoltaic modules M in the photovoltaic system 1 according to Embodiment 2 of the present invention.

The power conversion units 11 are individually connected to the photovoltaic modules M. For example, two power conversion units 11 are respectively connected to two photovoltaic modules M1, two power conversion units 11 are likewise respectively connected to two photovoltaic modules M2, and two power conversion units 11 are likewise respectively connected to two photovoltaic modules M3. Power conversion units 11 are similarly arranged for the other photovoltaic modules M (not shown) as well.

In other words, the photovoltaic system 1 includes power conversion units 11 that are connected to the photovoltaic modules M and perform DC-DC conversion on the output of the photovoltaic modules M, and the photovoltaic modules M are interconnected (connected) with each other via the power conversion units 11. Accordingly, in the photovoltaic system 1, since the photovoltaic modules M are interconnected with each other via the power conversion units 11 that perform DC-DC conversion on their output, thus making it possible to extract power that has been adjusted by the power conversion units 11 regardless of the power-generating state of the photovoltaic modules M. Note that the photovoltaic modules M1, the photovoltaic modules M2, the photovoltaic modules M3, and so on are connected in series via the power conversion units 11, and the power conversion units 11 are connected to each other in parallel via parallel wiring Wpc.

As described above, it is preferable that in the photovoltaic system 1, power conversion units 11 are individually connected to the photovoltaic modules M. Since, according to this configuration, the power conversion units 11 are individually connected to the photovoltaic modules M in the photovoltaic system 1, it is possible to individually convert the output of the photovoltaic modules M, thus making it possible to reliably and effectively suppress ohmic loss in the current pathways.

Also, it is preferable that the power conversion units 10 are implemented on the module implementation units Mj. Accordingly, since the power conversion units 10 are implemented on the module implementation units Mj of the photovoltaic modules M in the photovoltaic system 1, it is possible to substantially omit the arrangement process that accompanies the arrangement of the power conversion units 10, thus making the implementation of the power conversion units 10 similar to the implementation of the photovoltaic modules M, and ensuring reliability of the power conversion units 10. Implementing the power conversion units 10 on the module implementation units Mj enables simplifying the wiring structure and improving reliability.

FIG. 10 is a schematic circuit diagram showing an overview of internal circuitry of the power conversion units 10 shown in FIG. 8.

The power conversion unit 10 includes an input port 14 that receives output from photovoltaic power from photovoltaic modules M (three photovoltaic modules M1 connected in parallel in the same series stage), a switching element 16 that serves as a circuit unit for performing DC-DC conversion on the output of the photovoltaic modules M, a control signal generation unit 17, a boosting coil Lc, a diode Dc, a smoothing capacitor Cc, and an output port 15 that outputs power resulting from the DC-DC conversion.

Through the following operation, power (voltage) input to the input port 14 is boosted by the power conversion unit 10 and output from the output port 15.

First, when the switching element 16 is on, current flows to the boosting coil Lc that configures a current pathway, and the boosting coil Lc accumulates energy. Next, when the switching element 16 is turned off, the boosting coil Lc discharges the accumulated energy in an attempt to maintain the current. When the energy is discharged from the boosting coil Lc, the voltage at the output port 15 is the result of the addition of the input voltage (output from the photovoltaic modules M) and the voltage of the boosting coil Lc, and therefore boosting is performed in the power conversion unit 10. Note that the smoothing capacitor Cc smoothes the output voltage so as to stabilize the output voltage.

On/off control of the switching element 16 is executed in accordance with a control signal Sgc transmitted from the control signal generation unit 17 to the switching element 16 (gate terminal). The control signal generation unit 17 can perform PWM (Pulse Width Modulation) control on the switching element 16 by changing the pulse width of the control signal Sgc, and therefore the boosting factor can be easily changed. Note that the control signal generation unit 17 can eliminate the need for external power supply by using voltage obtained from the ends of the smoothing capacitor Cc as a power supply.

As described above, it is preferable that the power conversion units 10 boost the output voltage of the photovoltaic modules M. Since, according to this configuration, the output voltage of the photovoltaic modules M is boosted in the photovoltaic system 1, the output current relatively decreases, thus suppressing the occurrence of ohmic loss caused by current in current pathways, and improving the power extraction efficiency.

Also, as a variation, it is preferable that the power conversion units 10 have a boosting factor that is fixed at one value. Since, according to this configuration, the power conversion units 10 have a boosting factor that is fixed at one value in the photovoltaic system 1, there is no need to adjust the control signal for controlling the boosting factor of the power conversion units 10, thus simplifying the control signal generation unit 17 so as to reduce the installation cost of the power conversion units 10, and improving reliability.

Note that although the above description pertains to the power conversion units 10, the power conversion units 11 (FIG. 9) can also have a similar configuration, but a description of this will not be given.

### EMBODIMENT 3

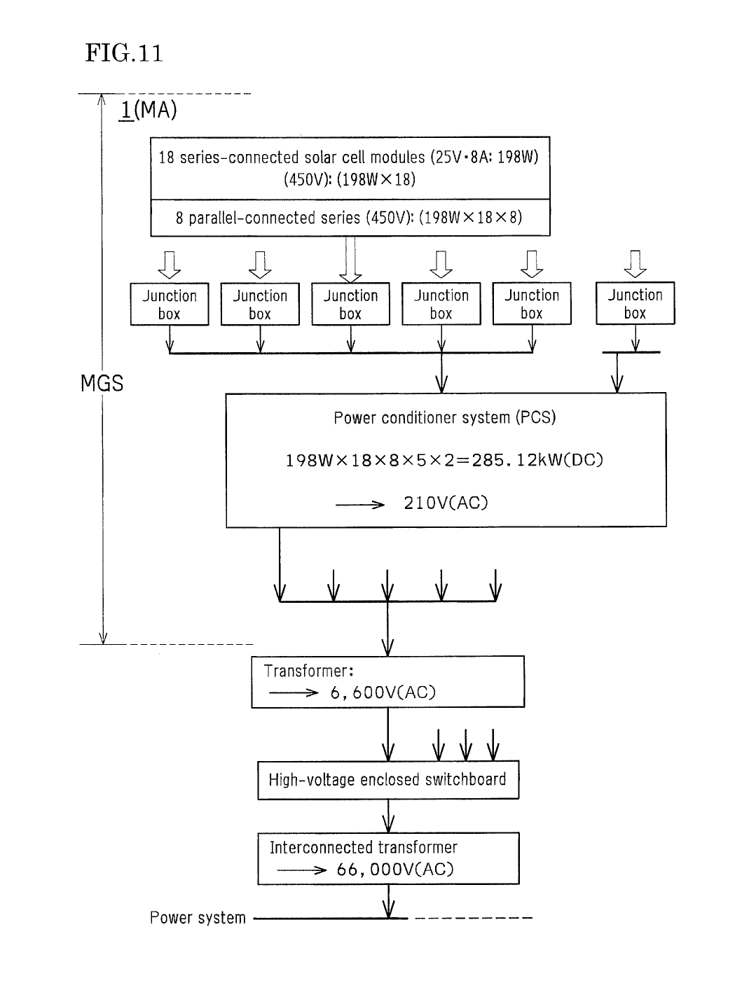

Embodiment 3 describes specific output of the photovoltaic system 1 according to Embodiment 1 or Embodiment 2 and system interconnection with a commercial power system, with reference to FIG. 11.

FIG. 11 is an output conceptual diagram conceptually showing output when system interconnection is carried out by connecting photovoltaic systems 1 according to Embodiment 3 of the present invention to a power system.

The photovoltaic system 1 is the photovoltaic module array MA (photovoltaic module array MAa or photovoltaic module array MAb of Embodiment 1) in which multiple photovoltaic modules M are connected. Also, the photovoltaic modules M are 25 V·8 A (198 W) modules for example, and 18 photovoltaic modules M are connected in series to achieve 450 V (198 W×18) for example. Also, eight groups of 18 series-connected photovoltaic modules M are connected in parallel such that 450 V (198 W×18×8) is output. In other words, the photovoltaic modules M configure the photovoltaic module array MA in an 18-series×8-parallel configuration.

The output of the photovoltaic module array MA (photovoltaic system 1) is connected in parallel with photovoltaic module arrays MA (photovoltaic systems 1) that are at four other locations and have similar configurations, and power is collected from these five locations overall and input to a power conditioner system PCS. Also, the power conditioner system PCS collects the output of one other group of photovoltaic module arrays MA (photovoltaic systems 1) at five locations in parallel, and converts the DC output from the two groups of photovoltaic systems 1 together into AC output. Specifically, the DC power input to the power conditioner system PCS (198 W×18×8×5×2) is in total 285.12 kW, which is converted in 210-V AC power.

Output of 1,000 kW or more can be obtained by using multiple power conditioner systems PCS to overall configure a mega solar power plant MGS. The power generated by the mega solar power plant MGS is input to a transformer and boosted to 6,600-V AC power by the transformer. The output of the transformer is collected in an interconnected transformer via a high-voltage enclosed switchboard, then converted to 66,000 V, and interconnected with a power system.

As described above, photovoltaic systems 1 of the present embodiment can configure a mega solar power plant MGS and be interconnected with an AC (commercial) power system. Also, since the application of the photovoltaic module array MA enables highly stably generating power while suppressing the influence of a shaded area SH, it is possible to configure a highly reliable power plant.

Embodiments 1 to 3 described above can be mutually applied to other embodiments by achieving technical compliance.

The present invention can be embodied in other forms without departing from the spirit or essential characteristics thereof. The foregoing embodiments are therefore to be considered in all respects as illustrative and not restrictive. The scope of the invention is indicated by the appended claims rather than by the foregoing description. Furthermore, all modifications and changes that come within the meaning and range of equivalency of the claims are intended to be embraced therein.

What is claimed is:

1. A photovoltaic system comprising:
a plurality of series module units in each of which a plurality of photovoltaic modules are connected in series, a plurality of photovoltaic elements being implemented on a module implementation unit in each of the photovoltaic modules,
wherein the series module units are connected to each other in parallel, and the photovoltaic modules arranged in a same series stage are connected to each other in parallel.

2. The photovoltaic system according to claim 1,
wherein the photovoltaic modules arranged in the same series stage in the series module units are arranged so as to be distributed two-dimensionally.

3. The photovoltaic system according to claim 1,
wherein the series module units are arranged two-dimensionally, and the photovoltaic modules in each of the series module units are arranged in a double-back pattern.

4. The photovoltaic system according to claim 1, further comprising:
power conversion units that are connected to the photovoltaic modules and perform DC-DC conversion on output of the photovoltaic modules,
wherein the photovoltaic modules are interconnected with each other via the power conversion units.

5. The photovoltaic system according to claim 4,
wherein the power conversion units boost an output voltage of the photovoltaic modules.

6. The photovoltaic system according to claim 5,
wherein the power conversion units have a boosting factor that is fixed at one value.

7. The photovoltaic system according to claim 4,
wherein the power conversion units are configured such that output of a plurality of the photovoltaic modules arranged in the same series stage in the series module units is input in parallel.

8. The photovoltaic system according to claim 7,
wherein the power conversion units are arranged so as to be distributed two-dimensionally.

9. The photovoltaic system according to claim 4,
wherein the power conversion units are individually connected to the photovoltaic modules.

10. The photovoltaic system according to claim 9,
wherein the power conversion units are implemented on the module implementation units.

11. The photovoltaic system according to claim 1,
wherein the photovoltaic modules each include series element units in each of which a plurality of the photovoltaic elements are connected in series,
the series element units are connected to each other in parallel, and the photovoltaic elements arranged in a same series stage are connected to each other in parallel, and
the photovoltaic elements arranged in the same series stage in the series element units are arranged so as to be distributed two-dimensionally.
